(19) United States
(12) Patent Application Publication
(10) Pub. No.: US 2004/0049436 A1
(43) Pub. Date: Mar. 11, 2004

(54) Payroll automation system

(75) Inventors: Zena Brand, New City, NY (US); Elisa Lane, Morristown, NJ (US); Richard Wilson, Randolph, NJ (US); Martin Fairbairn, Greetham (GB); Linda Mougalian, Wayne, NJ (US)

Correspondence Address: Thomas A. Walsh, ICE MILLER, One American Square, Box 82001, Indianapolis, IN, 46282-0002, US

(73) Assignee: ADP, Inc., Roseland, NJ

(21) Appl. No.: 10/237,703

(22) Filed: Sep. 9, 2002

(51) Int. Cl. G06F 17/60

(52) U.S. Cl. 705/30

(57) ABSTRACT

A payroll system enabling online analysis of payroll information of a current pay period with payroll information of a prior pay period. An embodiment comprises a client computer, a video display, a server connected to the client computer, a database associated with the server with payroll information retrievably stored therein, and means for analyzing the payroll information before funds are disbursed, the means comprising at least one display page displayed on the video display, the display page comprising the payroll information from both a current and a prior pay period. Another embodiment comprises a method comprising the steps of providing a system comprising a client computer comprising a video display, a server operably connected to the client computer, and a database associated with the server, providing payroll information retrievably stored in the database, transmitting at least one display page comprising payroll information for display on the client computer's video display.

### BACKGROUND

Every employer is faced with the regular generation of payroll for its employees. Initially, payroll processing was an arduous manual task, requiring the responsible individual to compute the base pay, applicable taxes, and other deductions for each of the employer's employees. Initially, these calculations were performed by hand. Later, these calculations were performed with the assistance of adding machines, calculators, and, finally, computers. Over time, automated systems have been developed to calculate pay, produce payroll checks, and even to make the automatic payroll deposits into an employee's bank account for employees participating in a direct deposit program.

Prior art payroll automation systems generally provide a single quality control feature to give the employer some comfort that the current payroll is accurate. Specifically, these systems give the employer the ability to review the gross payroll elements and net payroll payment elements for the current pay period. Prior art payroll automation systems also provide the capability to print a payroll report for a pay period. If an employer desired to do any detailed analysis of its current payroll, the employer was required to use the printouts. In addition, if an employer desired to compare the payroll for a current pay period with payroll from a prior pay period, the employer was required to make a side-by-side comparison of lengthy printed reports for the pay periods under analysis. Thus, the identification of an inaccurate payroll data entry, an error in a payroll calculation, and/or payroll fraud could be analogized to finding a “needle in a haystack.” Any such payroll discrepancies that are not found in a timely fashion can be difficulty and potentially costly to correct.

For these reasons, it is desired to provide an employer with an improved payroll automation system having the ability to analyze the payroll in a myriad of respects appropriate to identifying inaccurate payroll events. It is further desired to provide an improved payroll automation system permitting straightforward comparison of payroll information for a current pay period to payroll information for a previous pay period.

### SUMMARY

The present invention comprises an improved payroll automation system having the ability to analyze the payroll in a myriad of respects to assist a user in identifying inaccurate payroll events. The improved payroll automation system of the present invention permits online comparison and analysis of payroll information of a current pay period with payroll information of a prior pay period.

An embodiment of the present invention comprises a system for payroll automation comprising a client computer comprising a video display means, a server operably connected to the client computer, a database associated with the server, payroll calculation results data retrievably stored in the database, and means for review of the payroll calculation results data before disbursements of funds are made pursuant to the payroll calculation results data, the means comprising at least one display page transmitted from the server to the client computer and displayed on the video display means of the client computer, the at least one display page comprising the payroll calculation results data.

In an aspect of this embodiment, the server comprises server memory, and the system further comprising means for obtaining the payroll calculation results data from the database and storing the payroll calculation results data in the server memory, wherein the at least one display page comprises embedded programming operable to obtain at least a portion of the payroll calculation results data from the server memory and operable to insert the portion of the payroll calculation results data into the at least one display page. The payroll calculation results data may be formatted in the server memory using XML tags, with the embedded programming being operable to obtain at least a portion of the payroll calculation results data from the server memory according to the XML tags. Further, the embedded programming may comprise at least one JavaScript routine executable by the client computer.

In an aspect of this embodiment, the client computer is operated by a user, and the system further comprises means for authenticating the user before the at least one display page comprising the payroll calculation results data is transmitted to the client computer. Optionally, the means for authenticating the user comprises means for determining an extent to which the user may access the payroll calculation results data. The means for review of the payroll calculation results data then is operable in response to the determination to obtain a portion of the payroll calculation results data tailored for the user.

In an aspect of this embodiment, payroll data is retrievably stored in the database. The payroll calculation results data was computed from the payroll data. The at least one display page comprises at least one hyperlink that, when selected, causes at least a portion of the payroll data to be displayed on the video display means. The displayed payroll data is modifiable by a user of the client computer, with modifications to the payroll data being retrievably stored in the database.

In another embodiment, the present invention comprises a system for payroll automation comprising a client computer comprising a video display means, a server operably connected to the client computer, a database associated with the server, payroll calculation results data pertaining to a current pay period retrievably stored in the database, committed payroll data pertaining to at least one prior pay period retrievably stored in the database, and means for review of the payroll calculation results data and the committed payroll data before disbursements of funds are made pursuant to the payroll calculation results data, the means comprising at least one display page transmitted from the server to the client computer and displayed on the video display means of the client computer, the at least one display page comprising the payroll calculation results data and the committed payroll data.

In an aspect of this embodiment, the system further comprises means for obtaining the payroll calculation results data and the committed payroll data from the database and storing the payroll calculation results data and the committed payroll data in the server memory, wherein the at least one display page comprises embedded programming operable to obtain at least a portion of the payroll calculation results data and the committed payroll data from the server memory and operable to insert the portion of the payroll calculation results data and the committed payroll data into the at least one display page. The payroll calculation results data and the committed payroll data may be formatted in the server memory using XML tags, with the embedded programming being operable to obtain at least a portion of the payroll calculation results data and the committed payroll data from the server memory according to the XML tags. Further, the embedded programming may comprise at least one JavaScript routine executable by the client computer.

In an aspect of this embodiment, the client computer is operated by a user, and the system further comprises means for authenticating the user before the at least one display page comprising the payroll calculation results data and the committed payroll data is transmitted to the client computer. Optionally, the means for authenticating the user comprises means for determining an extent to which the user may access the payroll calculation results data and the committed payroll data. The means for review of the payroll calculation results data and the committed payroll data then is operable in response to the determination to obtain a portion of the payroll calculation results data and the committed payroll data tailored for the user.

In another embodiment, the present invention comprises a method for automation of payroll processing comprising the steps of providing a system comprising a client computer, a video display means electronically connected to the client computer, a server operably connected to the client computer, and a database associated with the server, providing payroll calculation results data retrievably stored in the database, transmitting at least one display page from the server to the client computer, the at least one display page comprising the payroll calculation results data, and displaying the at least one display page on the video display means of the client computer.

In an aspect of this embodiment, the step of providing payroll calculation results data comprises the steps of supplying payroll data at the client computer, transmitting the payroll data to the server, calculating the payroll calculation results data based on the payroll data at the server, and storing the payroll calculation results data in the database.

In an aspect of this embodiment, the at least one display page comprises a first and a second display page, the first display page comprising the payroll calculation results data displayed in a first level of detail, and the second display page comprising the payroll calculation results data displayed in a second level of detail, wherein the first display page comprises functionality enabling a user operating the client computer to request the second display page.

In another aspect of this embodiment, the at least one display page comprises the payroll calculation results data displayed in a first level of detail. The at least one display page also comprises functionality enabling a user operating the client computer to request the payroll calculation results data to be displayed in a second level of detail, with the payroll calculation results data being displayed in a second level of detail in response to the request.

In an aspect of this embodiment, the server comprises server memory, and the method further comprises, before the step of transmitting at least one display page from the server to the client computer, the steps of obtaining the payroll calculation results data from the database, and storing the payroll calculation results data in the server memory. According to an aspect of this embodiment, the step of displaying the at least one display page comprises the steps of executing programming embedded in the display page, the embedded programming being operable to obtain at least a portion of the payroll calculation results data from the server memory and being further operable to insert the portion of the payroll calculation results data into the at least one display page. The payroll calculation results data may be formatted in the server memory using XML tags, with the embedded programming being operable to obtain at least a portion of the payroll calculation results data from the server memory according to the XML tags. Further, the embedded programming may comprise at least one JavaScript routine executable by the client computer.

In an aspect of this embodiment, the client computer is operated by a user, and the method further comprises, before the step of transmitting at least one display page from the server to the client computer, the step of authenticating the user. Optionally, the step of authenticating the user may comprise the step of determining an extent to which the user may access the payroll calculation results data. The at least one display page transmitted from the server to the client computer then is tailored for the user in response to the determination.

In an aspect of this embodiment, payroll data pertaining to a current pay period is retrievably stored in the database. The payroll calculation results data were computed from this current pay period payroll data. The at least one display page comprises at least one hyperlink that, when selected, causes at least a portion of the current pay period payroll data to be displayed on the video display means. The current pay period payroll data is modifiable by a user of the client computer, with modifications to the current pay period payroll data being retrievably stored in the database.

In an aspect of this embodiment, the step of providing payroll calculation results data retrievably stored in the database comprises the steps of providing payroll data retrievably stored in the database, computing payroll calculation results data from the payroll data, and retrievably storing the payroll calculation results data in the database. The display page comprises at least one hyperlink that, when selected, causes at least a portion of the payroll data to be displayed on the video display means. The method further comprising the steps of selecting the hyperlink, modifying at least a portion of the payroll data, and retrievably storing the modified payroll data in the database.

In another embodiment, the present invention comprises a method for automation of payroll processing comprising the steps of providing a system comprising a client computer, a video display means electronically connected to the client computer, a server operably connected to the client computer, and a database associated with the server, providing payroll calculation results data pertaining to a current pay period retrievably stored in the database, providing committed payroll data pertaining to at least one prior pay period retrievably stored in the database, transmitting at least one display page from the server to the client computer, the at least one display page comprising the payroll calculation results data and the committed payroll data, and displaying the at least one display page on the video display means of the client computer.

In an aspect of this embodiment, the step of providing payroll calculation results data comprises the steps of supplying payroll data at the client computer, transmitting the payroll data to the server, calculating the payroll calculation results data based on the payroll data at the server, and storing the payroll calculation results data in the database.

In an aspect of this embodiment, the at least one display page comprises a first and a second display page, the first display page comprising the payroll calculation results data and the committed payroll data displayed in a first level of detail, and the second display page comprising the payroll calculation results data and the committed payroll data displayed in a second level of detail, wherein the first display page comprises functionality enabling a user operating the client computer to request the second display page.

In another aspect of this embodiment, the at least one display page comprises the payroll calculation results data and the committed payroll data displayed in a first level of detail. The at least one display page comprises functionality enabling a user operating the client computer to request the payroll calculation results data and the committed payroll data to be displayed in a second level of detail. The payroll calculation results data and the committed payroll data are displayed in a second level of detail in response to the request.

In an aspect of this embodiment, the server comprises server memory, and the method further comprises, before the step of transmitting at least one display page from the server to the client computer, the steps of obtaining the payroll calculation results data and the committed payroll data from the database, and storing the payroll calculation results data and the committed payroll data in the server memory. According to an aspect of this embodiment, the step of displaying the at least one display page comprises the step of executing programming embedded in the display page, the embedded programming being operable to obtain at least a portion of the payroll calculation results data and the committed payroll data from the server memory and being further operable to insert the portion of the payroll calculation results data and the committed payroll data into the at least one display page. The payroll calculation results data and the committed payroll data may be formatted in the server memory using XML tags, with the embedded programming being operable to obtain at least a portion of the payroll calculation results data and the committed payroll data from the server memory according to the XML tags. Further, the embedded programming may comprise at least one JavaScript routine executable by the client computer.

In an aspect of this embodiment, the client computer is operated by a user, and the method further comprises, before the step of transmitting at least one display page from the server to the client computer, the step of authenticating the user. Optionally, the step of authenticating the user comprises the step of determining an extent to which the user may access the payroll calculation results data and the committed payroll data. The at least one display page transmitted from the server to the client computer then is tailored for the user in response to the determination.

In an aspect of this embodiment, the step of providing payroll calculation results data retrievably stored in the database comprises the steps of providing payroll data pertaining to the current pay period retrievably stored in the database, computing payroll calculation results data from the current pay period payroll data, and retrievably storing the payroll calculation results data in the database. The display page comprises at least one hyperlink that, when selected, causes at least a portion of the current pay period payroll data to be displayed on the video display means. The method further comprising the steps of selecting the hyperlink, modifying at least a portion of the current pay period payroll data and retrievably storing the modified current pay period payroll data in the database.

In an embodiment, the present invention comprises a method for automation of payroll processing comprising the steps of providing a system comprising a client computer, a video display means electronically connected to the client computer, a server operably connected to the client computer, and a database associated with the server, providing a first set of general ledger data retrievably stored in the database, transmitting at least one display page from the server to the client computer, the at least one display page comprising the first set of general ledger data, and displaying the at least one display page on the video display means of the client computer.

In an aspect of this embodiment, the at least one display page comprises the first set of general ledger data displayed in a first level of detail, and wherein the at least one display page comprises functionality enabling a user operating the client computer to request the first set of general ledger data to be displayed in a second level of detail, with the first set of general ledger data being displayed in a second level of detail in response to the request.

In another embodiment, the present invention comprises a method for automation of payroll processing comprising the steps of providing a system comprising a client computer, a video display means electronically connected to the client computer, a server operably connected to the client computer, and a database associated with the server, providing a first set of general ledger data pertaining to a current general ledger period retrievably stored in the database, providing a second set of general ledger data pertaining to at least one prior general ledger period retrievably stored in the database, transmitting at least one display page from the server to the client computer, the at least one display page comprising the first set of general ledger data and the second set of general ledger data pertaining, and displaying the at least one display page on the video display means of the client computer.

In an aspect of this embodiment, the at least one display page comprises the first set of general ledger data and the second set of general ledger data displayed in a first level of detail, and wherein the at least one display page comprises functionality enabling a user operating the client computer to request the first set of general ledger data and the second set of general ledger data to be displayed in a second level of detail, with the first set of general ledger data and the second set of general ledger data being displayed in a second level of detail in response to the request.

These and other features and advantages of the present invention, and the manner of attaining them, will be more apparent and better understood by reference to the following descriptions of embodiments of the invention taken in conjunction with the accompanying drawings and with the appended claims.

### BRIEF DESCRIPTION OF THE DRAWINGS

FIG. 1 shows a block diagram of an embodiment of a payroll automation system according to the present invention.

FIG. 2A shows a flow chart illustrating the operation of an embodiment of a payroll automation system according to the present invention.

FIG. 2B shows a flow chart illustrating the operation of an embodiment of a payroll automation system according to the present invention.

FIG. 3 shows a pictorial view of an exemplary display page according to an embodiment of a payroll automation system of according to the present invention.

FIG. 4 shows a pictorial view of an exemplary display page comprising summary payroll calculation data compiled according to an embodiment of a payroll automation system of the present invention.

FIG. 5A shows a pictorial view of an exemplary display page comprising post-calculation review data compiled according to an embodiment of a payroll automation system of the present invention.

FIG. 5B shows a pictorial view of an exemplary display page comprising post-calculation review data compiled according to an embodiment of a payroll automation system of the present invention.

FIG. 6 shows a pictorial view of an exemplary display page according to an embodiment of a payroll automation system of the present invention which permits a user thereof to request a customized report of payroll calculation data.

### DESCRIPTION

The present invention comprises an improved payroll automation system having the ability to analyze the payroll in a myriad of respects to assist a user in identifying inaccurate payroll events. The improved payroll automation system of the present invention permits online comparison and analysis of payroll information of a current pay period with payroll information of a prior pay period, before the payroll information of the current pay period is committed.

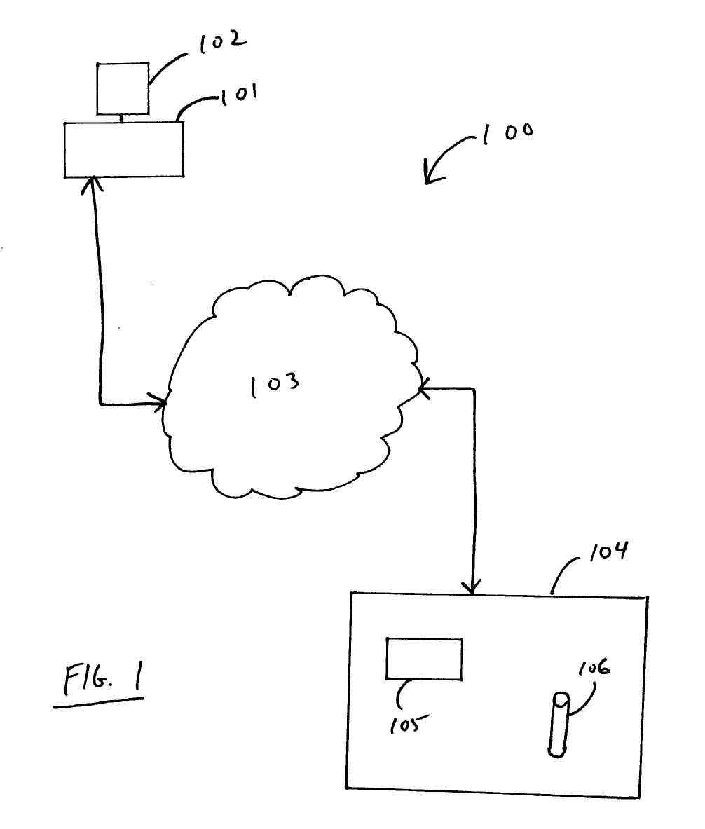

FIG. 1 shows a block diagram of an embodiment of payroll automation system 100 of the present invention. Shown in FIG. 1 are client computer 101, video display means 102, network 103, server 104, server memory 105, and database 106.

Client computer 101 is a computer, computing device, or system of a type known in the art, such as a personal computer, mainframe computer, workstation, notebook computer, laptop computer, hand-held computer, wireless mobile telephone, personal digital assistant device, and the like. Client computer 101 comprises such software (operational and application), hardware, and componentry as would occur to one of skill of the art, such as, for example, one or more microprocessors, memory, input/output devices, device controllers, and the like. Client computer 101 also comprises one or more data entry means (not shown in FIG. 1) operable by a user (not shown in FIG. 1) of client computer 101, such as, for example, a keyboard, keypad, pointing device, mouse, touchpad, touchscreen, microphone, and/or other data entry means known in the art. Client computer 101 also may comprise an audio display means (not shown in FIG. 1) such as one or more loudspeakers and/or other means known in the art for emitting an audibly perceptible output. The configuration of client computer 101 in a particular implementation of the present invention is left to the discretion of the practitioner.

Video display means 102 comprises a device upon which information may be displayed in a manner perceptible to the user, such as, for example, a computer monitor, cathode ray tube, liquid crystal display, light emitting diode display, touchpad or touchscreen display, and/or other means known in the art for emitting a visually perceptible output. Video display means 102 is electronically connected to client computer 101 according to hardware and software means known in the art.

For purposes of clarity, only one client computer is shown in FIG. 1. However, it is within the scope of the present invention, and it will be appreciated by those of ordinary skill in the art, that the system of the present invention may have two or more client computers operating concurrently. Each such computer may be operated by one or more users.

Server 104 comprises one or more server computers, computing devices, or systems of a type known in the art. Server 104 comprises server memory 105. Server memory 105 comprises one or more components of solid-state electronic memory, such as random access memory. Server 104 also comprises an electromagnetic memory such as one or more hard disk drives and/or one or more floppy disk drives or magnetic tape drives, and may comprise an optical memory such as a Compact Disk Read Only Memory (CD-ROM) drive. Server 104 further comprises such software (operational and application), hardware, and componentry as would occur to one of skill of the art, such as, for example, microprocessors, input/output devices, device controllers, video display means, and the like.

For purposes of clarity, server 104 is shown in FIG. 1 and referred to herein as a single server. Server 104 need not, however, be a single server. Server 104 may comprise a plurality of servers or other computing devices or systems interconnected by hardware and software means known in the art which collectively are operable to perform the functions allocated to server 104 according to the present invention. In an embodiment, server 104 comprises a Microsoft) Internet Information Server with one or more remote data storage server computers electronically interconnected therewith. Other embodiments of the present invention may comprise a web server such as, for example, an Apache™ web server, a Novell® web server, a Netscape® web server, an IBM® web server, or another web server known in the art. In an embodiment of the present invention, server 104 is operated by, or under the control of, a payroll automation service provider that provides payroll automation services concurrently to a plurality of employers.

Database 106 is “associated with” server 104. According to the present invention, database 106 is “associated with” server 104 where, as in the embodiment shown in FIG. 1, database 106 resides on server 104. Database 106 also is “associated with” server 104 where database 106 resides on a server or computing device remote from server 104, provided the remote server or computing device is capable of bi-directional data transfer with server 104. Preferably, the remote server or computing device upon which database 106 resides is electronically connected to server 104 such that the remote server or computing device is capable of continuous bi-directional data transfer with server 104.

For purposes of clarity, database 106 is shown in FIG. 1 and referred to herein as a single database. It will be appreciated by those of ordinary skill in the art that database 106 may comprise a plurality of databases connected by software means, which collectively are operable to perform the functions delegated to database 106 according to the present invention. Database 106 may comprise a relational database architecture or other database architecture of a type known in the database art. Database 106 may comprise one of many well known database management systems, such as, for example, Microsoft® SQL Server™, Microsoft® Access®, IBM® DB2®, or the database management systems available from Oracle® or Sybase®. In an embodiment of the present invention where server 104 is operated by, or under the control of, a payroll automation service provider providing concurrent payroll automation services to a plurality of employers, database 106 may contain data pertaining to employees of the plurality of employers.

Server 104 is operably connected to client computer 101 by a network 103, which in an embodiment of the present invention comprises the Internet, a global computer network. However, network 103 need not comprise the Internet. Network 103 may comprise any means for electronically interconnecting server 104 and client computer 101. Thus, it will be appreciated by those of ordinary skill in the art that network 103 may comprise the Internet, the commercial telephone network, one or more local area networks, one or more wide area networks, one or more wireless communications networks, coaxial cable, fiber optic cable, twisted-pair cable, the equivalents of any of the foregoing, or the combination of any two or more of the foregoing. In an embodiment where server 104 and client computer 101 comprise a single computing device operable to perform the functions delegated to both server 104 and client computer 101 according to the present invention, network 103 comprises the hardware and software means interconnecting server 104 and client computer 101 within the single computing device.

As used herein, the term “display page” means a computer file which is transmitted from server 104 over network 103 to a client computer, such as, for example, client computer 101. At client computer 101, the display page is interpreted by a software means residing on client computer 101, causing the computer file to be displayed on video display means 102 in a manner perceivable by a user. The display pages described herein may be created using a software language known in the art such as, for example, the hypertext mark up language (“HTML”), the dynamic hypertext mark up language (“DHTML”), the extensible hypertext mark up language (“XHTML”), the extensible mark up language (“XML”), or another software language that may be used to create a computer file displayable on video display means 102 in a manner perceivable by a user. Where network 103 comprises the Internet, a display page may comprise a webpage of a type known in the art.

A display page according to the present invention may include embedded functions comprising software programs, such as, for example, VBScript routines, JScript routines, JavaScript routines, Java applets, or ActiveX components. A display page according to the present invention may be an Active Server Page.

A display page may comprise well known features of graphical user interface technology, such as, for example, frames, windows, scroll bars, buttons, icons, and hyperlinks, and well known features such as a “point and click” interface. Pointing to and clicking on a graphical user interface button, icon, or hyperlink also is known as “selecting” the button or hyperlink. A display page according to the present invention also may incorporate multimedia features.

According to an embodiment of the present invention, a user uses client computer 101 to connect electronically to network 103. Residing on the processing means (not shown in FIG. 1) of client computer 101 is a software means such as Microsoft® Internet Explorer™ or Netscape® Communicator®, or another software means known in the art that is operable to request and interpret display pages. Residing on client computer 101 and on server 104 are software means known in the art for communicating with network 103, and software means known in the art for exchanging information over network 103 in a manner comprehended by software means residing on server 104 and on client computer 101. During operation of this embodiment of the present invention, communication between server 104, network 103, and client computer 101 is achieved by means known in the art for communicating with and through a network, such as, for example, communication in accordance with the transmission control protocol/Internet protocol (“TCP/IP”), the hypertext transfer protocol (“HTTP”), the file transfer protocol (“FTP”), the wireless access protocol (“WAP”), and/or other communication protocols known in the art.

In an embodiment of the present invention, a user finds a first Uniform Resource Locator (“URL”) address, which is the URL address of a first display page stored on server 104. The software means of client computer 101 sends an electronic request containing the URL address of the desired display page of server 104 over network 103. Such electronic request is interpreted by network 103, which processes such request to result in connection to server 104 as identified by its URL address. At this point, client computer 101 is in bidirectional communication with server 104. Server 104 then causes the desired display page to be sent over network 103 for receipt by client computer 101. The desired display page then is displayed on video display means 102 of client computer 101 in a manner perceivable by the user. If appropriate, data may be entered by the user at client computer 101 and transmitted to and received by server 104, with server 104 responding to such data entry according to the software means residing thereon. This process may be repeated (usually at the option of the user), with a plurality of display pages being displayed on video display means 102 as a result.

Where the display page comprises a point and click interface, by selecting one or more icons, buttons, or hyperlinks, a user may cause client computer 101 and server 104 to execute certain computer operations. For example, a display page may comprise one or more icons, buttons, and/or hyperlinks that may be operable, when selected by a user, to cause client computer 101 to transmit an electronic request for another display page to server 104 through network 103. Such electronic request is interpreted by network 103, which processes such request to result in connection to server 104. Server 104 then causes the desired display page to be sent over network 103 for receipt by client computer 101. The desired display page then is displayed on video display means 102 of client computer 101 in a manner perceivable by a user. Similarly, a display page may comprise one or more buttons, icons, and/or hyperlinks that may be operable, when selected by a user, to cause client computer 101 and/or server 104 to execute or to continue executing one or more software programs embedded in the display page, such as, for example, a client-side JavaScript routine, or a server-side VBScript or JScript routine, or server-side ActiveX Data Objects programming.

It will be appreciated by those of ordinary skill in the art that other means known in the art may be used for establishing bi-directional communication between server 104 and client computer 101. For example, client computer 101 may be in bi-directional communication with a second server computer having a hyperlink to the URL address of a display page stored on server 104. Selection of that hyperlink by a user results in bi-directional communication between client computer 101 and server 104.

It is customary in the payroll processing art that employees are paid at regular intervals known as “pay periods” which usually are chosen by an employer. It is most common that employees are paid weekly, biweekly, semimonthly, or monthly, although other pay periods are possible. The payroll automation system of the present invention is adaptable for any pay period desired by an employer.

It also is known in the payroll processing art to summarize payroll expenses according to a “cost center” structure. This is particularly true for larger employers. By grouping employees into cost centers and summarizing payroll expenses according to cost centers, a more accurate financial picture of an employer may be developed. Managers with responsibility for a cost center can review actual payroll expenses for a current pay period versus actual payroll expenses for a prior pay period for the cost center.

In addition, according to the present invention, employees of an employer may be grouped into “pay groups” by the employer. Typically, employees in a pay group have one or more characteristics in common. For example, hourly employees may be grouped into a first pay group, and salaried employees into a second pay group. In another example, employees of a first organizational unit (such as a department) may be grouped into a first pay group, and employees of a second organizational unit may be grouped into a second pay group. In yet another example, employees paid according to a biweekly pay period may be grouped into a first pay group, and employees paid according to a monthly pay period may be grouped into a second pay group. The definition of pay groups is left to the discretion of a practitioner of the present invention. The payroll automation system of the present invention is adaptable to handle any number of pay groups having any number or employees per pay group, according to the desires of an employer. However, in an embodiment of the present invention employees having different pay periods cannot be in the same pay group.

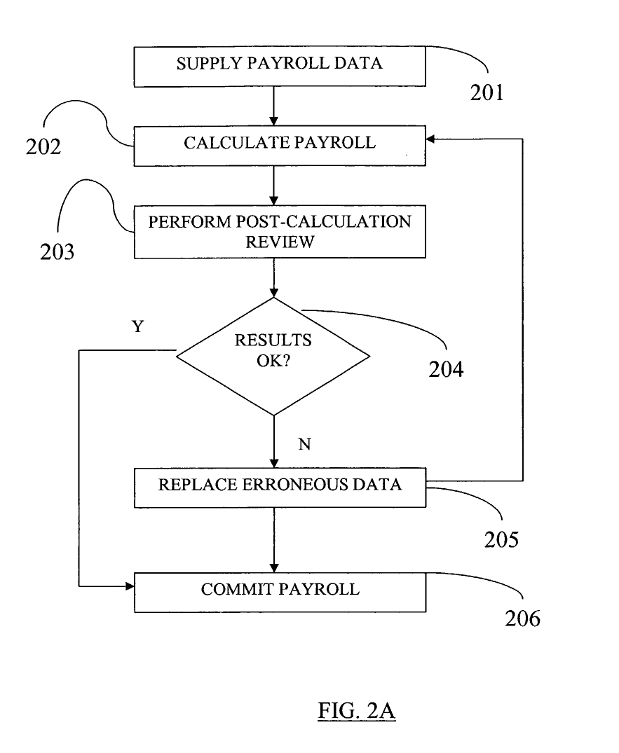

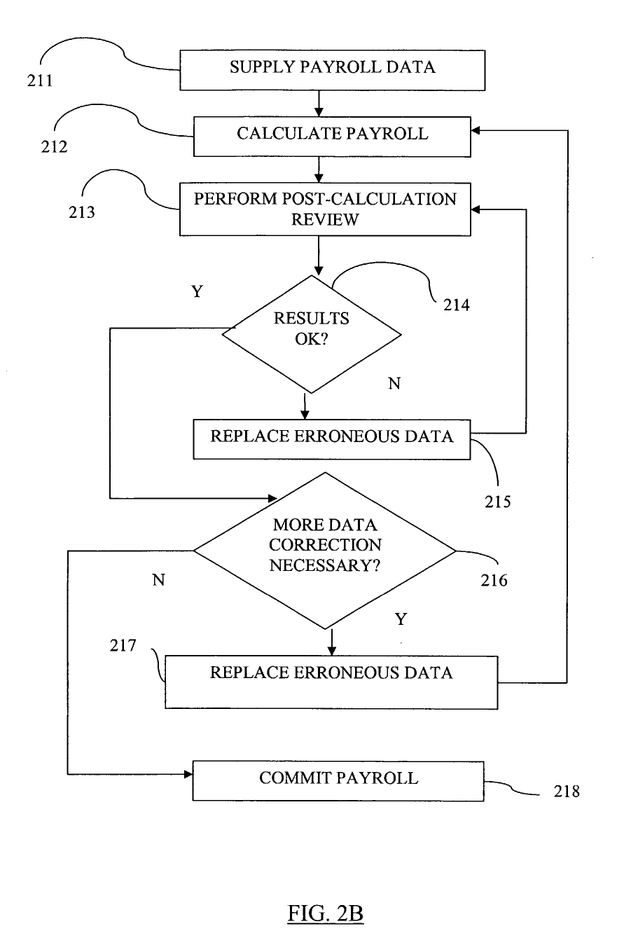

The present invention may take on one of several embodiments which enable a user operating client computer 101 to interact with server 104 according to the system shown in FIG. 1 and, in so doing, to process payroll. FIG. 2A shows a flow chart illustrating the operation of an embodiment of the payroll automation system of the present invention. In a typical implementation of this embodiment, the payroll automation system receives an employer's payroll data as an input, and provides output comprising payroll disbursements to the employer's employees; payroll-related disbursements to government bodies, insurance companies, and the like; and payroll-related communications to employers and third parties. A payroll disbursement may be in the form of a printed payroll check, a direct payroll deposit into an employee's bank account, and/or another payroll disbursement medium known in the art such as, for example, a stored value card. A payroll-related disbursement also may be in check form, or may be in the form of an electronic funds transfer. A payroll-related communication may be an electronic message to a software application under the control of the employer or a third party. The electronic message may contain information such as, for example, information about contributions to the retirement accounts or 401(k) accounts of one or more employees that accrued during the current pay period. The software application receiving the payroll-related electronic message is configured to respond to the electronic message in some manner. Such payroll-related communications may be sent to, for example, the employer, third party benefit plan administrator(s), union pension fund(s), and the like.

In the step shown as block 201 of FIG. 2A, the user supplies payroll data to the payroll automation system. In a typical implementation of this embodiment, the user is an employee, supervisor, or manager of the employer with responsibility for employee payroll processing. Payroll data is supplied for each employee of the employer. This embodiment of the present invention comprises one or more display pages formatted to improve the ability of the user to supply payroll data for each employee. For example, the display page(s) of this embodiment may comprise pre-prepared data entry fields into which the payroll data may be entered, such as through the use of one or more data entry means of client computer 101. In addition, for those employees for whom all or a portion of their payroll data remains consistent from one pay period to the next (such as many salaried employees) the display pages provided for the user to supply payroll data may contain the expected payroll data for such employees, thus requiring the user merely to confirm that the payroll data is unchanged from the prior pay period.

The payroll data to be supplied in a particular implementation of the payroll automation system of the present invention is left to the discretion of the practitioner of that implementation. The possible types of payroll data which may be provided to the payroll automation system of the present invention comprise any type of compensation and deduction data that would occur to those of skill in the payroll art. For example, payroll data may comprise compensation data such as salary, wage rate and hours worked, bonus compensation, commissions, overtime compensation, holiday compensation, and the like. Payroll data may further comprise deduction data such as federal, state, and local income tax withholding parameters, health insurance premiums, life insurance premiums, disability insurance premiums, garnishments, and the like.

Payroll data also may comprise information about employees of the employer. For example, payroll data may comprise the name, address, and Social Security Number of each new employee, and the name, address, and Social Security Number of each employee whose employment has terminated. Similarly, payroll data may comprise information about a change in an employee's pay rate arising, for example, from an increase in the employee's salary or from the employee reaching a tenure threshold causing an automatic increase in the employee's hourly wage rate. Likewise, payroll data may comprise information about a change in an employee's deductions such as, for example, a change in an employee's federal income tax withholding parameters or a change in an employee's health insurance premium.

After the user has supplied payroll data to the automated payroll system of the present invention, payroll is calculated in the step shown as block 202 of FIG. 2A. The payroll data supplied by the user is transmitted to server 104 from client computer 101 through network 103, and retrievably stored in database 106. Calculation of the employer's payroll then is accomplished using payroll calculation software means residing on or associated with server 104.

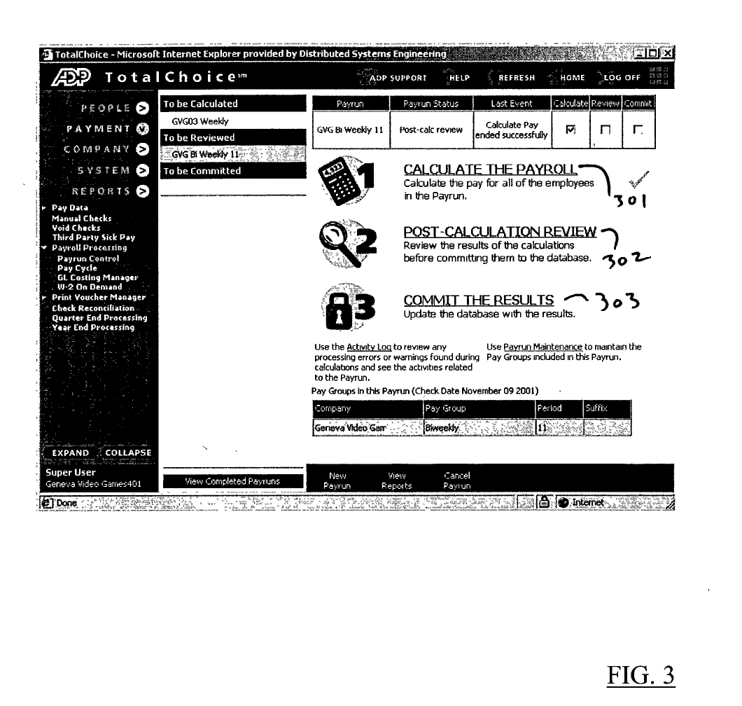

In an embodiment of the present invention, payroll calculation is initiated when the user selects a button or hyperlink configured for that purpose. FIG. 3 shows a pictorial view of an exemplary display page which may be displayed to the user after the user has supplied payroll data to the payroll automation system of the present invention. Shown in FIG. 3 is hyperlink 301 labeled “CALCULATE THE PAYROLL.” Selection of hyperlink 301 by the user causes the software means residing on or associated with server 104 to begin calculating the payroll.

Payroll calculation according to the present invention is an automatic process performed without further interaction by the user. During the step of calculating the payroll, each employee's gross pay is calculated by the payroll calculation software means residing on or associated with server 104. The payroll calculation software means subtracts payroll deductions, garnishments, taxes, and the like from the gross pay to produce the employee's net pay. The disbursement(s) of employer's total payroll that are to be distributed to each employee and to other entities also are calculated by the payroll calculation software means. The results of the payroll calculation are retrievably stored in database 106.

In an embodiment of the present invention where server 104 is operated by, or under the control of, a payroll automation service provider that provides payroll automation services to more than one employer, it is known in the art to calculate each employer's payroll in a batch or batches. The employer's batch(es) are submitted for calculation along with the batch(es) received by the payroll automation service provider from other employers. If the batches submitted for calculation exceed the capacity of server 104 to calculate the payroll, the batches are queued for processing. Typically, batches are retrieved from the queue in a first-in, first-out manner. When calculation of the employer's payroll is complete, this embodiment of the payroll automation system of the present invention is operable to send an electronic message to an appropriate point of contact at the employer notifying that individual that the payroll calculation is complete.

After the payroll calculation is performed in the step shown as block 202 of FIG. 2A, it often is desirable for the employer to review the payroll calculation results prior to the time that funds are disbursed to employees, government entities, and other third parties. By verifying the payroll calculation results at this time, the employer may uncover payroll errors or payroll fraud before funds are disbursed. The employer saves time, money, and resources by uncovering and correcting payroll problems before they manifest into overpayments or underpayments to employees, former employees, government entities, and other third parties. Post-calculation payroll review is performed during the step shown as block 203 of FIG. 2A.

The present invention comprises a novel method for post-calculation payroll review. As discussed previously herein, prior art methods for post-calculation payroll review involved tedious, error-prone examination of lengthy paper reports. The payroll automation system of the present invention comprises software means interfacing with client computer 101, server 104, server memory 105, and database 106 to enable paperless review of payroll calculation results. The software means for paperless review of payroll calculation results is integrated with the payroll automation system of the present invention, so that paperless review of payroll calculation results may be accomplished “in-line” with the other steps in the payroll processing process. The present invention does not require the payroll calculation results to be exported or transferred to a companion or third party software program for paperless review. Such an arrangement requires substantial costs to initialize the third party software program for paperless review and to maintain the third party software program for paperless review as new payroll calculation results data is developed each pay period. In addition, the use of a companion or third party software program for paperless review adds an additional step and additional time to the post-calculation payroll review process, and deprives the user of the many advantages of the integrated, in-line review made possible through the use of the payroll automation system of the present invention.

The payroll automation system is operable to perform a post-calculation payroll review analyzing the payroll calculation results for the current pay period. The payroll automation system also is operable to perform a post-calculation payroll review comparing the payroll calculation results of the current pay period with data from a prior pay period. For example, an employer may find it useful to compare the payroll calculation results of the current pay period with data from the most recent prior pay period while highlighting the differences between the two pay periods. Alternatively, the employer may find it useful to compare the payroll calculation results of the current pay period with data from another prior pay period such as, for example, a pay period occurring six months or one year previously.

In an embodiment of the present invention, post-calculation payroll review is initiated when the user selects a button, icon, or hyperlink configured for that purpose. FIG. 3 shows a pictorial view of a display page which may be displayed on video display means 102 by an embodiment of the payroll automation system of the present invention. Shown in FIG. 3 is hyperlink 302 labeled “POST-CALCULATION REVIEW.” Selection of hyperlink 302 by the user begins the post-calculation payroll review process in this embodiment.

When the user initiates the post-calculation payroll review phase, such as, for example, when the user selects hyperlink 302 in FIG. 3, the employer's payroll calculation results data is obtained from database 106 and stored in server memory 105. Server memory 105 thus contains a virtual representation of the employer's entire payroll calculation results data set for the current pay period as stored in database 106. The payroll calculation results data elements stored in server memory 105 are formatted using XML tags. Also obtained from database 106 and stored in server memory 105 is committed payroll data for at least one prior pay period (provided, of course, that committed payroll data exists in database 106 for at least one prior pay period). Server memory 105 thus contains a virtual representation of the committed payroll data for the at least one prior pay period. The committed payroll data for the at least one prior pay period also is formatted using XML tags. The XML tags are interpretable by the display page's embedded programming executing on client computer 101, as will be shown hereinafter.

Although it is not necessary to use the virtual representation in server memory 105 of the entire employer's payroll calculation results data set, doing so is preferred because it enhances the efficiency of the post-calculation payroll review step. Storing the complete set of payroll calculation results data in server memory 105 reduces the need for repetitive accessing of the permanent memory of server 104 (such as the hard disk drive(s) of server 104) to obtain data from database 106. This is particularly valuable when server 104 is operated by, or under the control of, a payroll automation service provider providing payroll automation services to a plurality of employers. Concurrent and repetitive access of the hard disk drive(s) of server 104 by a plurality of users attempting to obtain the payroll calculation results data of a plurality of employers for post-calculation review would result in slow response times for all users. By uploading each employer's data to server memory 105 in full for the purpose of post-calculation payroll review, concurrent access of server 104 by a plurality of users is more efficient.

In conjunction with the uploading of the employer's payroll calculation results data into server memory 105, a display page is transmitted from server 104 to client computer 101, processed by client computer 101, and displayed on video display means 102. The display page comprises embedded programming that executes on client computer 101. The embedded programming supports the operation of the paperless post-calculation payroll review method of the present invention. In an implementation of this embodiment, the display page comprises an XML data island, which is a technique known in the art for inserting XML formatted data into an HTML document, and the embedded programming comprises a JavaScript routine which executes on client computer 101 when the display page is processed by client computer 101.

After post-calculation payroll review is initiated and the display page is transmitted from server 104 to client computer 101, the display page's embedded programming running on client computer 101 obtains the appropriate data from the XML formatted virtual representation of payroll calculation results data in server memory 105 according to XML tags of the data elements, and inserts the data into the display page. If applicable, the appropriate data from the XML formatted virtual representation of the committed payroll data from the prior pay period also is obtained from server memory 105 and inserted into the display page. The data inserted into the display page is known as “post-calculation review data.” During the post-calculation review process, actual data is not downloaded to the client computer 101, except as inserted into a display page. Accordingly, there is no data “residue” left in the memory of client computer 101 after the post-calculation payroll review is complete.

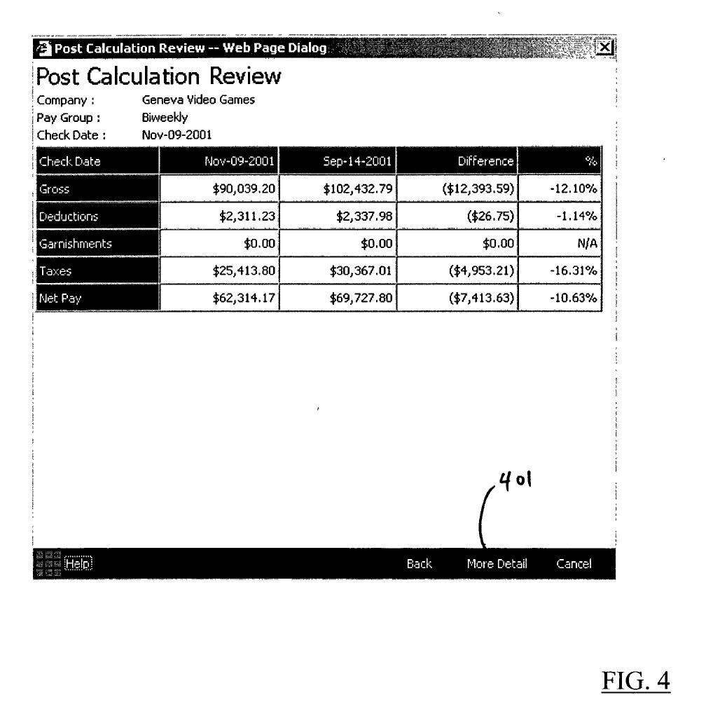

In an embodiment of the present invention, the display page's embedded programming is operable to permit the post-calculation review data to be revealed in two or more different levels of detail. FIG. 4 shows a pictorial view of an exemplary display page comprising summary post-calculation review data. Shown in FIG. 4 is a post-calculation review summary for a fictional employer “Geneva Video Games,” comprising information about gross pay, deductions, garnishments, taxes, and net pay for the payroll calculation data of the then-current pay period (the column labeled “Nov. 9, 2001”), and for committed payroll data for a prior pay period (the column labeled “Sep. 14, 2001”). The discrepancies between the data for the two pay periods under analysis are calculated by the present invention, and are shown in FIG. 4 both in absolute terms (the column labeled “Difference”) and percentage terms (the column labeled “%”).

Shown in FIG. 4 are graphical user interface buttons labeled “Help,” “Back,” and “Cancel.” The functionality of each button corresponds to its label. Also shown in FIG. 4 is graphical user interface button 401 labeled “More Detail.” By selecting graphical user interface button 401, the user may enhance the analysis of the post-calculation review data, increasing the likelihood that unexpected payroll discrepancies are discovered. Selection of graphical user interface button 401 causes the display page's embedded programming to reveal the post-calculation review data in a greater level of detail. In an embodiment, selection of graphical user interface button 401 causes a display page to be transmitted from server 104 to client computer 101, processed by client computer 101, and displayed on video display means 102. The display page comprises embedded programming which executes on client computer 101, and which supports the operation of the paperless post-calculation review method of the present invention. In an implementation of this embodiment, the display page comprises an XML data island and the embedded programming comprises a JavaScript routine. When the display page's embedded programming is executed by client computer 101, the appropriate data is retrieved from server memory 105, and then inserted into the display page displayed on video display means 102.

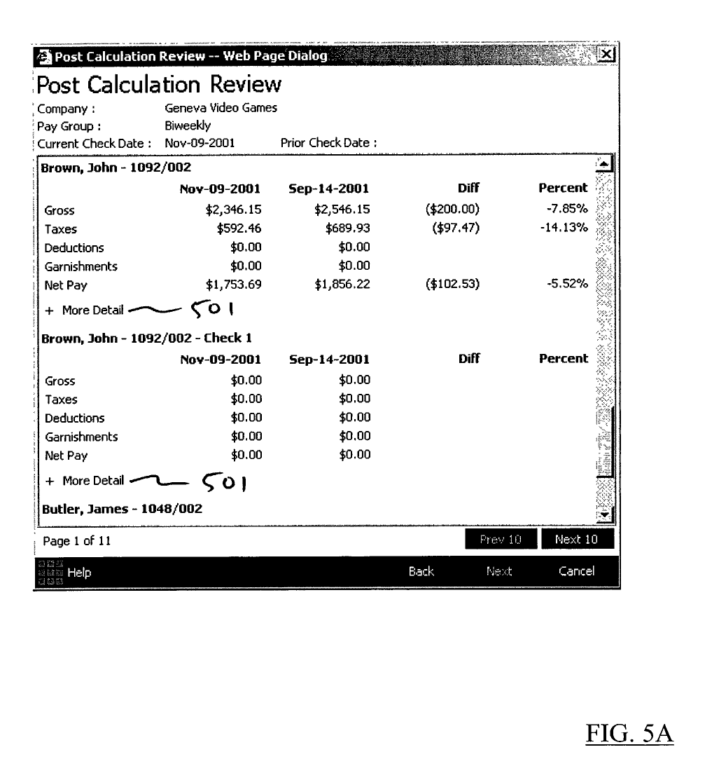

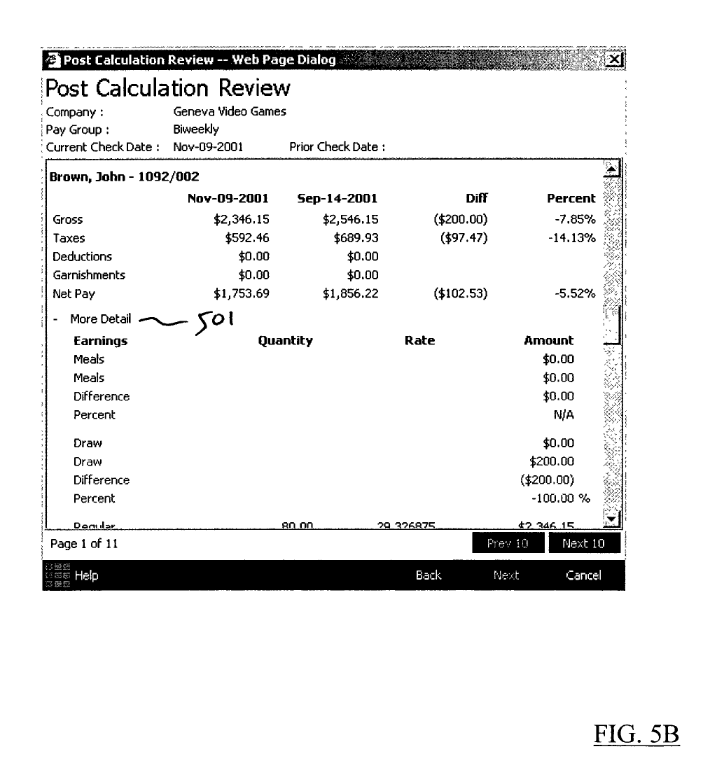

FIG. 5A shows a pictorial view of an exemplary display page which may be displayed on video display means 102 when the user selects graphical user interface button 401. Post-calculation review data for fictional Geneva Video Games employee “John Brown” is shown in FIG. 5A. Information about gross pay, taxes, deductions, garnishments, and net pay for each employee for each of the pay periods under analysis also is shown. Discrepancies between the pay periods in each category are given in absolute terms and percentage terms.

Also shown in FIG. 5A are hyperlinks 501 labeled “+More Detail”. Selecting one of these hyperlinks causes the display page's embedded programming to reveal the post-calculation review data in a greater level of detail. FIG. 5B shows a pictorial view of an exemplary display page which may be displayed on video display means 102 when the user selects the hyperlink 501 associated with fictional employee John Brown in the display page shown in FIG. 5A. Shown in FIG. 5B is the same information about gross pay, taxes, deductions, garnishments, and net pay for John Brown shown in the display page of FIG. 5A. Also shown in FIG. 5B is other information about John Brown's payroll. Such information may be useful in uncovering an inaccuracy in John Brown's payroll calculation. Note that the label of hyperlink 501 is changed to “−More Detail” in shown in the display page of FIG. 5B. Selecting hyperlink 501 in the display page shown in of FIG. 5B reveals the post-calculation review data in a lesser level of detail, such as the level of detail shown in the display page of FIG. 5A.

In an embodiment of the present invention, the display page comprising post-calculation review data is operable to display the post-calculation review data in two or more levels of detail without the need for requesting a new display page from server 104. According to this embodiment, the display page comprises embedded programming enabling certain post-calculation review data to be revealed at the direction of the user. Referring back to the exemplary display pages of FIGS. 5A-B, post-calculation review data is shown in a certain level of detail in the display page of FIG. 5A. Selection of hyperlink 501 in the display page shown in FIG. 5A (labeled “+More Detail”) causes the post-calculation review data to be revealed in a another, different level of detail. This different level of detail is shown in FIG. 5B. Conversely, selection of the hyperlink 501 (labeled “−More Detail”) in the display page shown in FIG. 5B causes the post-calculation review data to be revealed in the previous level of detail. This “toggling” between levels of detail is accomplished without further interaction with server 104. Instead, all post-calculation review data necessary for the display of the different levels of detail and the second level of detail is inserted in the display page when it is downloaded from server 104, and the embedded programming of the display page then operable to reveal the post-calculation review data according to the level of detail selected by the user. In addition, this embodiment of the present invention is not limited to toggling between only two levels of detail. Toggling between three or more levels of detail may be accomplished in this embodiment of the present invention.

Accordingly, the novel post-calculation review method of the present invention enables a user to “drill down” into the post-calculation review data. At each step, the user can request “more detail,” with the post-calculation review data being displayed in a finer degree of resolution upon each such request by the user. Payroll discrepancies which would have been difficult to discover under the prior art manual post-calculation payroll review methods are readily discoverable using the novel post-calculation review process of the present invention.

In an embodiment, a display page showing post-calculation review data in a level of detail wherein data about individual employees is displayed, such as the exemplary display page shown in FIGS. 5A-B, comprises one or more hyperlinks. Such a hyperlink is configured so that, when selected by the user, the hyperlink reveals payroll data pertaining to the employee. The user then may make corrections to the employee's payroll data without terminating the post-calculation payroll review phase. For example, if it is identified during post-calculation payroll review that an employee's payroll deduction caused an incorrect amount to be deducted from the employee's payroll, a hyperlink may be provided. The selection of the hyperlink causes a display page comprising the deduction information for the employee. The erroneous deduction information then could be corrected by a user operating data entry means of client computer 101. After making the correction, the user could return to the post-calculation payroll review at the point the user left the post-calculation payroll review to correct the erroneous deduction information.

FIG. 2B shows a flow chart illustrating the operation of this embodiment of the present invention. The steps shown as blocks 211, 212, and 213 correspond to the steps shown as blocks 201, 202, and 203 of FIG. 2A. In block 214 of FIG. 2B, the user determines whether the payroll calculation results are correct. If not, in the step shown as block 215 the user supplies accurate payroll data to replace the erroneous payroll data discovered during the post-calculation review step. The user then returns to the post-calculation review step. This cycle of steps comprising post-calculation review and payroll data correction are performed iteratively until the user determines, in the step shown in block 214, that the payroll data is satisfactory.

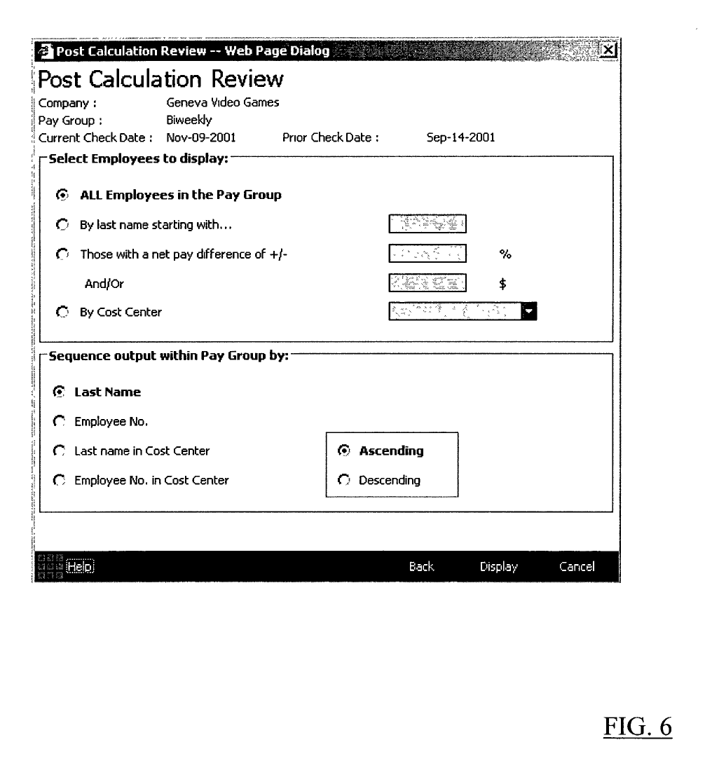

In addition to enabling a user to drill down from a post-calculation review summary, the novel post-calculation review method of the present invention also permits the user to obtain customized reports from the XML formatted virtual representation of the data stored in server memory 105. FIG. 6 shows a pictorial view of an exemplary display page which may be displayed on video display means 102 and which permits the user to request a customized report of the post-calculation review data. As shown in FIG. 6, the user may request a report according to employees' last name, according to employees' cost center, or according to the difference (in absolute or percentage terms) in employees' net pay between a first and a second pay period. The display page shown in FIG. 6 represents only one possible implementation. Other implementations may use such other report customizing criteria as would occur to one of skill in the art. For example, the user may request a report showing the employer's payroll related liability for items such as the employer's obligation to make a contribution to the employees' 401(k) plan, or the employer's obligation for employment related taxes.

In addition, the user may use the exemplary display page shown in FIG. 6 to specify a sequence for the presentation of the data obtained from server memory 105. For example, the data may be sequenced ascendingly or descendingly according to the employee's last name or the employee's employee number. Alternatively, a first level ascending or descending sequencing may be applied according to the employee's cost center, and then the data within a cost center may be sequenced ascendingly or descendingly according to the employee's last name or the employee's employee number. The display page shown in FIG. 6 represents only one possible implementation. Other implementations may use such other criteria for sequencing report data as would occur to one of skill in the art.

In an embodiment, the post-calculation review is limited to groupings of one thousand employees. However, this limit is selectable and may be less than or greater than this number in other embodiments. Selection of the employee limit often depends on the bandwidth available for data transfer between client computer 101 and server 104. In a high bandwidth connection, a larger number of employees is possible. Conversely, in a lower bandwidth connection, a smaller number of employees is possible.

Referring back to FIG. 2A, the user, having performed a post-calculation review in the step shown as block 203, determines whether the payroll calculation results are correct in the step shown as block 204. If not, in the step shown as block 205 the user supplies accurate payroll data to replace erroneous payroll data discovered during the post-calculation review step. Then the user causes the payroll automation system of the present invention to calculate the payroll again in the step shown as block 202. This cycle of steps comprising post-calculation review, payroll data correction, and payroll re-calculation are performed iteratively until the user determines, in an iteration of the step shown as block 204, that the payroll calculation results are accurate. The user then commits the payroll results in the step shown as block 206.

Referring back to the embodiment of the present invention shown in FIG. 2B, in the step shown as block 216, the user determines whether erroneous payroll data exists that was not correctable during the post-calculation payroll review process. If so, in the step shown as block 217, the user supplies accurate payroll data to replace erroneous payroll data. The user then causes the payroll automation system of the present invention to calculate the payroll again in the step shown as block 212. This cycle of steps comprising post-calculation review, payroll data correction, and payroll re-calculation are performed iteratively until the user determines, in the steps shown as block 216, that the payroll calculation results are accurate. Then the user commits the payroll results in the steps shown as block 218.

In an embodiment of the present invention, the commitment of the payroll is initiated when the user selects a button or hyperlink configured for that purpose. Referring back to FIG. 3 there is shown a pictorial view of a display page which may be displayed to the user by an embodiment of the payroll automation system of the present invention. Shown in FIG. 3 is hyperlink 303 labeled “COMMIT THE RESULTS.” Selection of hyperlink 303 by the user begins the payroll commitment process in this embodiment.

After the user commits the employer's payroll, such as, for example, when the user selects hyperlink 203 in FIG. 3, software means residing on or associated with server 104 executes the process of finalizing the payroll for the pay period. Earnings statements are prepared for the each employee. Payroll checks are printed for those employees receiving their pay in that form. Funds are electronically transmitted into the employee's bank account for those employees participating in a direct deposit program. Payroll is disbursed to those employees receiving payroll in other payroll disbursement media known in the art such as, for example, a stored value card. Payroll-related disbursements are made to government entities and other third parties on behalf of the employer and/or employees. Reports are prepared for the employer showing the final figures for the pay period. Payroll-related communications are sent to the appropriate parties. After the user commits the employer's payroll, further revisions to the employer's payroll data involve a significantly more time-consuming, labor-intensive, and protracted process.

After the user commits the employer's payroll in the step shown block 206 of FIG. 2A or the step shown as block 218 of FIG. 2B, the employer's committed payroll data for the current pay period may be posted to the employer's general ledger. According to the present invention, a “general ledger period” comprises one or more pay periods. A “current general ledger period” comprises the current pay period, and also may comprise one or more previous pay periods. “General ledger data” comprises committed payroll data for a general ledger period. Thus, “current general ledger data” comprises committed payroll data for the current pay period, and also may comprise committed payroll data for one or more previous pay periods. Current general ledger data is not yet posted to the employer's general ledger. “Costed general ledger data” comprises committed payroll data for a previous general ledger period, after the committed payroll data has been posted to the employer's general ledger.

The step of posting the employer's current general ledger data to a general ledger is not shown in FIG. 2A or FIG. 2B. The process of posting the employer's current general ledger data comprises allocating the employees' earnings, taxes, and deductions for the current general ledger period among the employer's various general ledger cost accounts. It is within the scope of the present invention to adapt the present invention to permit paperless review of the employer's current general ledger data before it is posted to the employer's general ledger.

Such an adaptation of the present invention comprises software means interfacing with client computer 101, server 104, server memory 105, and database 106 to enable paperless review of the employer's general ledger data. This adaptation of the present invention is analogous to the system and method for performing post-calculation payroll review described herein. The software means for paperless review of the employer's general ledger data is integrated with the payroll automation system of the present invention, so that paperless review of the employer's general ledger data may be accomplished “in-line” with the other steps in the payroll processing process. The present invention does not require the employer's committed payroll data or general ledger data to be exported or transferred to a companion or third party software program for paperless review.

The paperless review of the employer's general ledger data can comprise analyzing only the employer's current general ledger data. The payroll automation system also can comprise a review of the employer's general ledger data comparing the current general ledger data with costed general ledger data from a prior general ledger period. For example, an employer may find it useful to compare its current general ledger data with costed general ledger data from the most recent prior general ledger period, while highlighting the differences between data from the two general ledger periods. Alternatively, the employer may find it useful to compare the employer's current general ledger data with costed general ledger data from another prior general ledger period such as, for example, a general ledger period occurring six months or one year previously.

According to the present invention, current general ledger data and costed general ledger data are retrievably stored in database 106. Upon request by a user of the payroll automation system of the present invention, the employer's current general ledger data is retrieved from database 106 and inserted into a display page that is displayed on video display means 102. Costed general ledger data from a prior general ledger period also may be retrieved from database 106 and inserting it into a display page that is displayed on video display means 102. The step of retrieving general ledger data and inserting it into a display page comprises the methods and technologies analogous to those discussed herein in regard to the system and method for post-calculation payroll review.

Normally, general ledger data is organized in the display page according to an employer-defined cost account structure. Preferably, discrepancies between the employer's current general ledger data and the costed general ledger data for the chosen prior general ledger period are highlighted.

The user may review the current general ledger data as allocated among the general ledger accounts with like information for at least one prior general ledger period. Ordinarily, the general ledger data first appears in the display page at a summary level of detail. The employer may “drill down” into the data in an attempt to uncover any unexpected discrepancies and the source(s) thereof. The user may reallocate the current general ledger data period among the various general ledger accounts, and then perform another review of the current general ledger data. Note, however, that the total payroll expense for the current general ledger period is committed and fixed. The only changes that the user can make involve reallocation of the payroll expenses among the employer's cost accounts. After the user is satisfied with the results of the review, the user may release the current general ledger data for posting to the employer's general ledger.

The payroll automation system of the present invention can be adapted to include security features. For example, the payroll automation system of the present invention an be adapted to use encryption, such as the well known secure sockets layer (“SSL”), public key infrastructure (“PKI”), or other encryption methods known in the art.

In addition, the payroll automation system of the present invention can be adapted to require user authentication before the user is permitted to enter payroll data, to review post-calculation results data, or to otherwise access database 106. In one embodiment, user authentication is accomplished by the use of a username and/or password which preferably are unique to the user. According to this embodiment, a display page is transmitted to client computer 101. Using one or more data entry means of client computer 101, the user supplies a username and/or password to the display page, and this information is transmitted to sever 104. Software means residing on server 104 is operable to compare the username and/or password supplied by the user with authentic username and/or password data previously stored in database 106. If the username and/or password supplied by the user matches the authentic username and/or password data previously stored in database 106, the next display page is transmitted to client computer 101 by server 104.

Several efficiencies and advantages may be realized if each user has a unique username and/or password. For example, where an employer has more than one user authorized to perform employee payroll processing duties, the activities of each user can be controlled. If the payroll automation system of the present invention is adapted to comprises a means for creating a log or record of each user's activities, changes to payroll data can be attributed to a particular user. This enhances the accountability of each user and reduces the opportunity for fraud or embezzlement.

In addition, in an embodiment of the present invention, the interaction between server 104 and a user operating client computer 101 takes place in the form of a series of display pages comprising server-executable embedded programming such as, for example, Active Server Pages. In this embodiment, database 106 is adapted to include information defining the scope of each user's access to the employer's payroll data. When the user accesses the payroll automation system, the user is identified through the user's unique username and/or password, and information about the user's scope of access then is obtained from database 106. When an Active Server Page comprising payroll data, post-calculation review data, or the like is delivered from server 104 to client computer 101 through network 103, programming embedded in the Active Server Page executes on server 104 before the display page is transmitted to client computer 101. Based on information about the user's scope of access obtained from database 106, the embedded programming is operable to obtain only the payroll data or payroll calculation results data within the user's scope of access, and to compile this data into the display page. Accordingly, the display page displayed on video display means 102 is tailored for the user. This embodiment of the present invention is particularly useful where the users are authorized by an employer to process only certain employees' payroll. For example, if a first payroll clerk has responsibility for a first pay group, and a second payroll clerk has responsibility for a second pay group, when the first payroll clerk enters his or her unique username and/or password, the Active Server Page delivered to the user's client computer 101 is operable to permit the first payroll clerk to access and update only the payroll data for the first pay group. In another example, where a payroll clerk is responsible for processing the payroll of only non-management employees, and a payroll supervisor is responsible for processing management and non-management payroll, through the use of unique usernames and/or passwords and Active Server Page technology, the payroll automation system of the present is operable to distinguish between the two users, and provide each user with the appropriate information.

Although the present invention is discussed herein as using payroll calculation results data and committed payroll data formatted using XML tags, in an alternate embodiment the present invention is adapted for use with payroll calculation results data and committed payroll data formatted using HTML tags.

Those of skill in the art will appreciate that the various software means recited herein and in the claims may be performed by computer software and/or computer hardware. Such computer software may be written in any programming language known in the art, such as, for example, Visual Basic, Java, C, C++, Pascal, Fortran, and the like.

The present invention comprises an improved payroll automation system having the ability to analyze payroll information to assist a user in identifying inaccurate payroll events. The improved payroll automation system of the present invention permits comparison of payroll information for a current pay period to payroll information for a prior pay period.

In addition, while this invention has been described as having a preferred design, the present invention can be further modified within the scope and spirit of this disclosure. This application is therefore intended to cover any variations, uses, or adaptations of the invention using its general principles. For example, the methods disclosed herein and in the appended claims represent one possible sequence of performing the steps thereof. A practitioner of the present invention may determine in a particular implementation of the present invention that multiple steps of one or more of the disclosed methods may be combinable, or that a different sequence of steps may be employed to accomplish the same results. Each such implementation falls within the scope of the present invention as disclosed herein and in the appended claims. Furthermore, this application is intended to cover such departures from the present disclosure as come within known or customary practice in the art to which this invention pertains and which fall within the limits of the appended claims.

We claim:

1. A system for payroll automation comprising:
a client computer comprising a video display means;
a server operably connected to said client computer;
a database associated with said server;
payroll calculation results data retrievably stored in said database; and
means for review of said payroll calculation results data before disbursements of funds are made pursuant to said payroll calculation results data, said means comprising at least one display page transmitted from said server to said client computer and displayed on said video display means of said client computer, said at least one display page comprising said payroll calculation results data.

2. The system of claim 1, wherein said server comprises server memory, said system further comprising:
means for obtaining said payroll calculation results data from said database and storing said payroll calculation results data in said server memory, wherein said at least one display page comprises embedded programming operable to obtain at least a portion of said payroll calculation results data from said server memory and operable to insert said portion of said payroll calculation results data into said at least one display page.

3. The system of claim 2, wherein said payroll calculation results data is formatted in said server memory using XML tags, and said embedded programming is operable to obtain at least a portion of said payroll calculation results data from said server memory according to said XML tags.

4. The system of claim 2, wherein said embedded programming comprises at least one JavaScript routine executable by said client computer.

5. The system of claim 1, wherein said client computer is operated by a user, the system further comprising:
means for authenticating said user before said at least one display page comprising said payroll calculation results data is transmitted to said client computer.

6. The system of claim 5, wherein:
said means for authenticating said user comprises means for determining an extent to which said user may access said payroll calculation results data; and
said means for review of said payroll calculation results data is operable in response to said determination to obtain a portion of said payroll calculation results data tailored for said user.

7. The system of claim 1, further comprising:
payroll data retrievably stored in said database, said payroll calculation results data having been computed from said payroll data, wherein said at least one display page comprises at least one hyperlink that, when selected, causes at least a portion of said payroll data to be displayed on said video display means, said payroll data being modifiable by a user of said client computer, with modifications to said payroll data being retrievably stored in said database.

8. The system of claim 1, wherein said payroll calculation results data pertains to a current pay period, the system further comprising:
committed payroll data pertaining to at least one prior pay period retrievably stored in said database; and
means for review of said payroll calculation results data and said committed payroll data before disbursements of funds are made pursuant to said payroll calculation results data, said means comprising at least one display page transmitted from said server to said client computer and displayed on said video display means of said client computer, said at least one display page comprising said payroll calculation results data and said committed payroll data.

9. The system of claim 8, wherein said server comprises server memory, said system further comprising:
means for obtaining said payroll calculation results data and said committed payroll data from said database and storing said payroll calculation results data and said committed payroll data in said server memory, wherein said at least one display page comprises embedded programming operable to obtain at least a portion of said payroll calculation results data and said committed payroll data from said server memory and operable to insert said portion of said payroll calculation results data and said committed payroll data into said at least one display page.

10. The system of claim 9, wherein said payroll calculation results data and said committed payroll data are formatted in said server memory using XML tags, and said embedded programming is operable to obtain at least a portion of said payroll calculation results data and said committed payroll data from said server memory according to said XML tags.

11. The system of claim 9, wherein said embedded programming comprises at least one JavaScript routine executable by said client computer.

12. The system of claim 8, wherein said client computer is operated by a user, the system further comprising:
means for authenticating said user before said at least one display page comprising said payroll calculation results data and said committed payroll data is transmitted to said client computer.

13. The system of claim 12, wherein:
said means for authenticating said user comprises means for determining an extent to which said user may access said payroll calculation results data and said committed payroll data; and
said means for review of said payroll calculation results data and said committed payroll data is operable in response to said determination to obtain a portion of said payroll calculation results data and said committed payroll data tailored for said user.

14. The system of claim 8, further comprising:
payroll data pertaining to a current pay period retrievably stored in said database, said payroll calculation results data having been computed from said current pay period payroll data, wherein said at least one display page comprises at least one hyperlink that, when selected, causes at least a portion of said current pay period payroll data to be displayed on said video display means, said current pay period payroll data being modifiable by a user of said client computer, with modifications to said current pay period payroll data being retrievably stored in said database.

15. A method for automation of payroll processing comprising the steps of:
providing a system comprising a client computer, a video display means electronically connected to said client computer, a server operably connected to said client computer, and a database associated with said server;
providing payroll calculation results data retrievably stored in said database;
transmitting at least one display page from said server to said client computer, said at least one display page comprising said payroll calculation results data; and
displaying said at least one display page on said video display means of said client computer.

16. The method of claim 15, wherein the step of providing payroll calculation results data comprises the steps of:
supplying payroll data at said client computer;
transmitting said payroll data to said server;
calculating said payroll calculation results data based on said payroll data at said server; and
storing said payroll calculation results data in said database.

17. The method of claim 15, wherein said at least one display page comprises said payroll calculation results data displayed in a first level of detail, and wherein said at least one display page comprises functionality enabling a user operating said client computer to request said payroll calculation results data to be displayed in a second level of detail, with said payroll calculation results data being displayed in a second level of detail in response to said request.

18. The method of claim 15, wherein said server comprises server memory, the method further comprising, before the step of transmitting at least one display page from said server to said client computer, the steps of:
obtaining said payroll calculation results data from said database; and
storing said payroll calculation results data in said server memory;
and wherein the step of displaying said at least one display page comprises the steps of:
executing programming embedded in said display page, said embedded programming being operable to obtain at least a portion of said payroll calculation results data from said server memory and being further operable to insert said portion of said payroll calculation results data into said at least one display page.

19. The method of claim 18, wherein said payroll calculation results data is formatted in said server memory using XML tags, and said embedded programming is operable to obtain at least a portion of said payroll calculation results data from said server memory according to said XML tags.

20. The method of claim 18, wherein said embedded programming comprises at least one JavaScript routine executable by said client computer.

21. The method of claim 15, wherein said client computer is operated by a user, the method further comprising, before the step of transmitting at least one display page from said server to said client computer, the step of authenticating said user.

22. The method of claim 21, wherein the step of authenticating said user comprises the step of:
determining an extent to which said user may access said payroll calculation results data, wherein said at least one display page transmitted from said server to said client computer is tailored for said user in response to said determination.

23. The method of claim 15, wherein the step of providing payroll calculation results data retrievably stored in said database comprises the steps of providing payroll data retrievably stored in said database; computing payroll calculation results data from said payroll data; and retrievably storing said payroll calculation results data in said database; and wherein said display page comprises at least one hyperlink that, when selected, causes at least a portion of said payroll data to be displayed on said video display means, the method further comprising the steps of:
selecting said hyperlink;
modifying at least a portion of said payroll data; and
retrievably storing said modified payroll data in said database.

24. The method of claim 15, wherein said payroll calculation results data pertains to a current pay period, the method further comprising, before the step of transmitting said at least one display page from said server to said client computer, the step of:
providing committed payroll data pertaining to at least one prior pay period retrievably stored in said database, wherein said at least one display page comprises said payroll calculation results data and said committed payroll data.

25. The method of claim 24, wherein the step of providing payroll calculation results data comprises the steps of:
supplying payroll data at said client computer;
transmitting said payroll data to said server;
calculating said payroll calculation results data based on said payroll data at said server; and
storing said payroll calculation results data in said database.

26. The method of claim 25, wherein said at least one display page comprises said payroll calculation results data and said committed payroll data displayed in a first level of detail, and wherein said at least one display page comprises functionality enabling a user operating said client computer to request said payroll calculation results data and said committed payroll data to be displayed in a second level of detail, with said payroll calculation results data and said committed payroll data being displayed in a second level of detail in response to said request.

27. The method of claim 24, wherein said server comprises server memory, the method further comprising, before the step of transmitting at least one display page from said server to said client computer, the steps of:
obtaining said payroll calculation results data and said committed payroll data from said database; and
storing said payroll calculation results data and said committed payroll data in said server memory;
and wherein the step of displaying said at least one display page comprises the step of:
executing programming embedded in said display page, said embedded programming being operable to obtain at least a portion of said payroll calculation results data and said committed payroll data from said server memory and being further operable to insert said portion of said payroll calculation results data and said committed payroll data into said at least one display page.

28. The method of claim 27, wherein said payroll calculation results data and said committed payroll data are formatted in said server memory using XML tags, and said embedded programming is operable to obtain at least a portion of said payroll calculation results data and said committed payroll data from said server memory according to said XML tags.

29. The method of claim 27, wherein said embedded programming comprises at least one JavaScript routine executable by said client computer.

30. The method of claim 24, wherein said client computer is operated by a user, the method further comprising, before the step of transmitting at least one display page from said server to said client computer, the step of authenticating said user.

31. The method of claim 30, wherein the step of authenticating said user comprises the step of:
determining an extent to which said user may access said payroll calculation results data and said committed payroll data, wherein said at least one display page transmitted from said server to said client computer is tailored for said user in response to said determination.

32. The method of claim 24, wherein the step of providing payroll calculation results data retrievably stored in said database comprises the steps of providing payroll data pertaining to said current pay period retrievably stored in said database; computing payroll calculation results data from said current pay period payroll data; and retrievably storing said payroll calculation results data in said database; and wherein said display page comprises at least one hyperlink that, when selected, causes at least a portion of said current pay period payroll data to be displayed on said video display means, the method further comprising the steps of:
selecting said hyperlink;
modifying at least a portion of said current pay period payroll data; and
retrievably storing said modified current pay period payroll data in said database.

33. A method for automation of payroll processing comprising the steps of:
providing a system comprising a client computer, a video display means electronically connected to said client computer, a server operably connected to said client computer, and a database associated with said server;
providing a first set of general ledger data retrievably stored in said database;
transmitting at least one display page from said server to said client computer, said at least one display page comprising said first set of general ledger data; and
displaying said at least one display page on said video display means of said client computer.

34. The method of claim 33, wherein said at least one display page comprises said first set of general ledger data displayed in a first level of detail, and wherein said at least one display page comprises functionality enabling a user operating said client computer to request said first set of general ledger data to be displayed in a second level of detail, with said first set of general ledger data being displayed in a second level of detail in response to said request.

35. The method of claim 33, wherein said first set of general ledger data pertains to a current general ledger period, the method further comprising, before the step of transmitting said at least one display page from said server to said client computer, the step of:
providing a second set of general ledger data pertaining to at least one prior general ledger period retrievably stored in said database, wherein said at least one display page comprises said first set of general ledger data and said second set of general ledger data.

36. The method of claim 35, wherein said at least one display page comprises said first set of general ledger data and said second set of general ledger data displayed in a first level of detail, and wherein said at least one display page comprises functionality enabling a user operating said client computer to request said first set of general ledger data and said second set of general ledger data to be displayed in a second level of detail, with said first set of general ledger data and said second set of general ledger data being displayed in a second level of detail in response to said request.
